(19) United States
(12) Patent Application Publication
(10) Pub. No.: US 2006/0080605 A1
(43) Pub. Date: Apr. 13, 2006

(54) Language editing system for a human-machine interface

(75) Inventor: Yung-Liang Chang, Taoyuan (TW)

Correspondence Address: Welsh & Katz, Ltd.;Eric D. Cohen, 22nd Floor, 120 South Riverside Plaza, Chicago, IL, 60606, US

(73) Assignee: Delta Electronics, Inc., Taoyuan (TW)

(21) Appl. No.: 10/963,180

(22) Filed: Oct. 12, 2004

(51) Int. Cl. G06F 9/00

(52) U.S. Cl. 715/703

(57) ABSTRACT

A language editing system for a human-machine interface is disclosed, the system comprises a language text editing unit for retrieving and editing text data of a menu item, and a language text database for providing the language text data needed by the language text editing unit. The user may edit text data of the menu item by themselves with the multi-language version of the menu item, thus providing more convenience in operating the human-machine interface.

### FIELD OF THE INVENTION

The invention relates to a menu editing system, and particularly to a language editing system for a human-machine interface.

### BACKGROUND OF THE INVENTION

With industrial automation becoming increasingly popular, operation control of various types of equipment may be performed through human-machine interfaces. Users can select a menu item on a human-machine interface to generate a corresponding action on a piece of equipment. Thus the equipment may be operated more conveniently.

Actual use experiences of customers show that the text displayed on the menu items should have language setting functions to match users who speak different languages. Due to capacity constraints of the human-machine interface, it is not possible to store the text data of every language in the human-machine interface. Hence the conventional human-machine interface generally includes only a few frequently used language versions to be displayed on the menu items. In general, the English version is one of the basic language settings. A couple of other language versions may be included. While this offers users some language options for selecting menu items, it becomes a problem when the equipment is installed and used in a country where the users do not speak the setting languages.

Hence how to allow users to edit the menu items of the human-machine interface according to their habits or familiar languages to improve operation convenience of the human-machine interface is one of issues remaining to be resolved in the industry.

### SUMMARY OF THE INVENTION

In view of the aforesaid disadvantages occurring with the conventional techniques, the primary object of the invention is to provide a language editing system for a human-machine interface that enables users to edit text data of menu items by themselves so that they can use a familiar operation interface to improve operation convenience of the human-machine interface.

In order to achieve the foregoing object, the language editing system for a human-machine interface according to the invention includes a language text editing unit and a language text database.

The language text editing unit aims to retrieve text data of menu items of a human-machine interface and edit the text of the menu items. The language text editing includes border-line settings, character font size and color, text direction and position.

The language text database provides language text data required by the language text editing unit. It may obtain a local language text through the language text database in the Windows operating system.

In addition, after users have finished editing, the edited menu items may be transmitted through a communication unit to a human-machine interface memory for storage. The communication unit may include a serial communication port (such as RS-232 or RS485), parallel communication port or Ethernet port (such as RJ-45), and the like.

In one aspect, the system according to the invention includes a menu item database and a language text editing unit.

The menu item database stores menu items in multi-language versions for user selection.

The language text editing unit is linked to the menu item database to edit text data of the menu items. The language text editing includes border-line settings, character font size and color, text direction and position.

Moreover, after users have finished editing, the edited menu items may be transmitted through a communication unit to a human-machine interface memory for storage. The communication unit may include a serial communication port (such as RS-232 or RS485), parallel communication port or Ethernet port (such as RJ-45), and the like.

Through the language editing system for a human-machine interface of the invention, users can select a language they are familiar with from the computer operating system to edit the text data of the menu items, and transmit the edited text data to the memory of the human-machine interface for storage. Thus the memory capacity of the human-machine interface does not have to be increased when a new language text is adopted. And the menu items may have multi-language versions to improve operation convenience of the human-machine interface.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of a first embodiment of the invention;

FIG. 2 is a system block diagram of a second embodiment of the invention;

FIG. 3 is a schematic view of an operation interface of the invention;

FIG. 4 is a schematic view of another operation interface of the invention;

FIG. 5 is a schematic view of yet another operation interface of the invention; and

FIG. 6 is a process flow chart of the invention.

### DESCRIPTION OF THE PREFERRED EMBODIMENTS

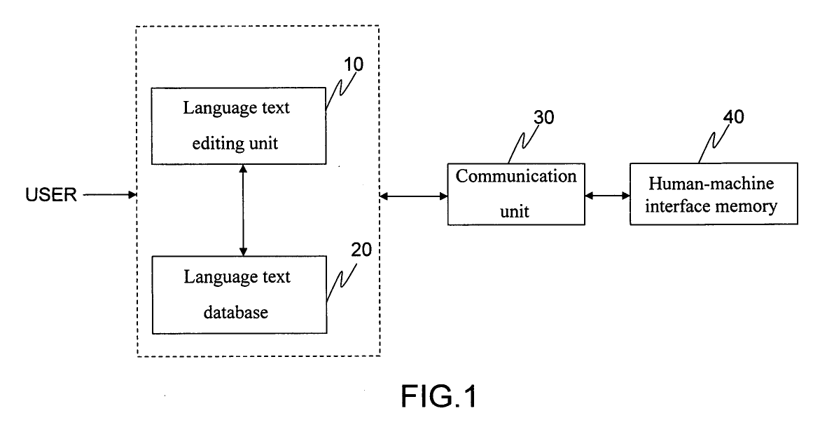

Refer to FIG. 1 for the system block diagram of a first embodiment of the invention. It includes a language text editing unit 10 and a language text database 20.

The language text editing unit 10 aims to retrieve language text data of menu items stored in a human-machine interface memory 40 and edit the language text of the menu items. The language text editing content includes border-line settings, character font size and color, text direction and position.

The border-line settings aim to set the text display within a frame or with no frame. The character font size is set according to the display resolution range (such as 8*8 pixels, 8*16 pixels, 16*16 pixels, 32*32 pixels, etc.) to adjust the display proportion of the text and prevent the text from becoming too large or too small and exceeding the display range. The character color aims to adjust the distribution ratio of the three primary colors (RGB) to alter the display color of the text to make the text display clearer. The text direction aims to adjust text layout sequence and direction (such as from left to right, or from right to left, or from up to down, or from down to up) to match text layout of different languages. The text position aims to adjust display position of the text (such as left side alignment, center alignment or right side alignment) to make text display layout neat and more appealing.

The language text database 20 stores the language text data in various languages to provide the required language text data for the language text editing unit 10 during editing. The language text database in the Windows operating system may be used for this purpose to enable users to select local language text data (such as Korean, Simplified Chinese, Traditional Chinese, Japanese, Hindi, Greek, etc.), or directly select the preset language text in the existing Windows operating system.

In addition, a communication unit 30 is provided to transmit data, and transport the text data edited by the language text editing unit 10 to the human-machine interface memory 40 for storage. This may be accomplished through a serial communication port (such as RS-232, RS-485 or RS-422), parallel communication port or Ethernet port (such as RJ-45) to connect the computer to the human-machine interface to transmit the data in a serial transmission, parallel transmission or TCP/IP fashion.

The human-machine interface memory 40 aims to store various setting values of the human-machine interface, including at least a language text setting area to provide the text data of menu items before editing to be retrieved by the language text editing unit 10, and to allow the edited text data of the menu items to be transported through the communication unit 30 to the human-machine interface memory 40 for storage.

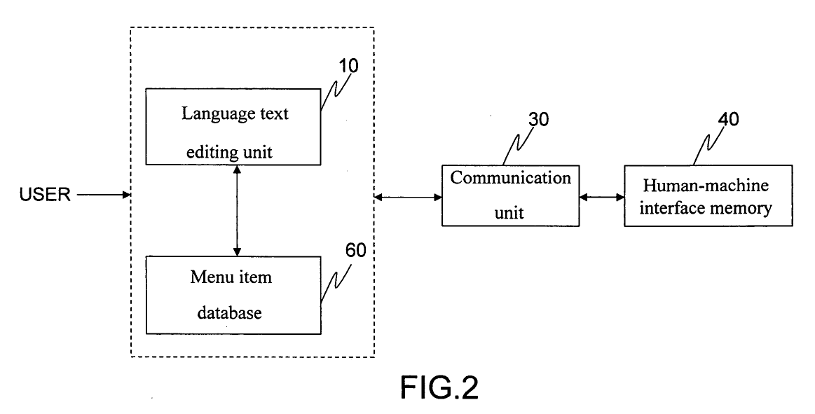

Refer to FIG. 2 for a system block diagram of a second embodiment of the invention. It includes a menu item database 60 and a language text editing unit 10.

The menu item database 60 stores multi-language versions of menu items for user selection. The menu items are classified according to the types of human-machine interfaces. This is because the hardware specifications of different human-machine interfaces vary, which affects the number of operable menu items. Hence users have to select and confirm through the types of human-machine interfaces before processing menu item editing operations at a later stage.

The language text editing unit 10 is linked to the menu item database 60 to edit the text data of the menu items. The language text editing content includes border-line settings, character font size and color, text direction and position. They are the same as those previously discussed, so details are omitted here.

The communication unit 30 aims to transport the text data edited by the language text editing unit 10 to the human-machine interface memory 40 for storage. This may be accomplished through a serial communication port (such as RS-232, RS-485 or RS-422), parallel communication port or Ethernet port (such as RJ-45) to connect the computer to the human-machine interface to transmit the data in a serial transmission, parallel transmission or TCP/IP fashion.

The human-machine interface memory 40 aims to store various setting values of the human-machine interface, including at least a language text setting area to allow the edited text data of the menu items to be transported through the communication unit 30 to the human-machine interface memory 40 for storage.

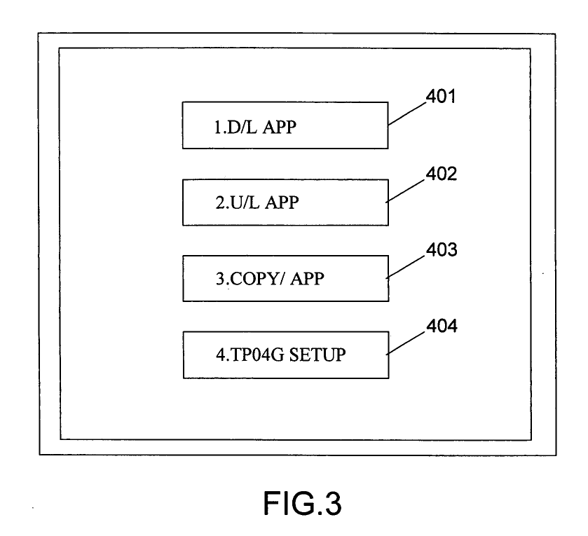

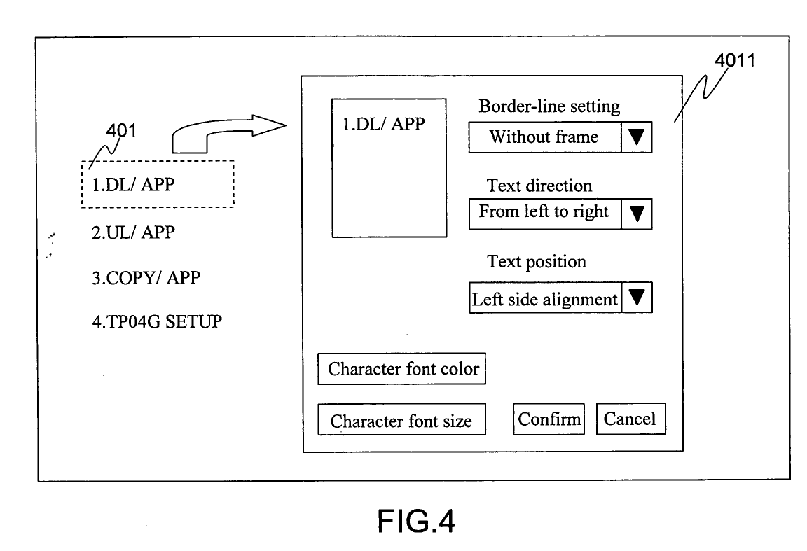

Refer to FIG. 3 for an operation interface according to the invention. First, a user connects a human-machine interface to a computer. The language text editing unit 10 retrieves text data of menu items from the human-machine interface memory 40, including menu items 401 “1. D/L APP,” menu item 402 “2. U/L APP,” menu item 403 “3. COPY APP,” and menu item 404 “4. TP04G SETUP.” Referring to FIG. 4, after selecting the menu item 401 “1. D/L APP,” the editing system initiates an editing window 4011 to allow the user to perform the editing process. Next, the user changes the text “1. D/L APP” to “1. Download application programs” by selecting the traditional Chinese fonts from the language text database. It has to be noted that “1. Download application programs” is represented in traditional Chinese, where is translated into English for reference. The same approach may be used to change the text of the menu items located below. In addition, the user can perform other text editing processes on the editing window 4011, such as setting border-lines (with or without frame), character font size and color, text direction (such as from left to right, or from right to left, or from up to down, or from down to up), and text position (such as left side alignment, center alignment or right side alignment).

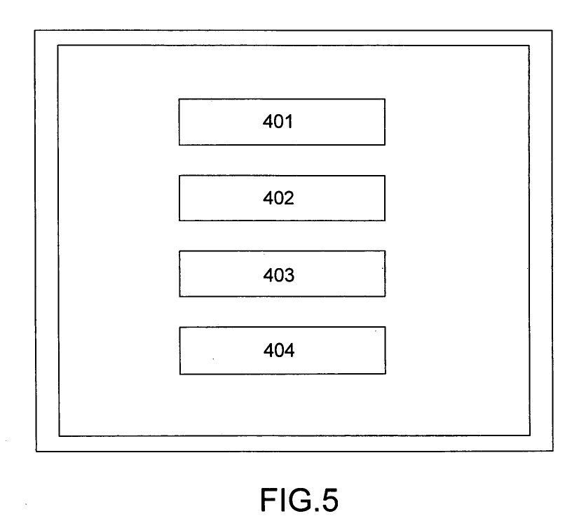

Referring to FIG. 5, after the user has pressed the “Confirm” function key, the menu item 401 changes to “1. Download application programs”. It has to be noted that “1. Download application programs” is represented in traditional Chinese, where is translated into English for reference. Next, the user can transmit the edited text data of the menu item to the human-machine interface memory 40 for storage through a serial transmission, parallel transmission or TCP/IP fashion. Thus multi-language versions of the menu item operation interface may be obtained.

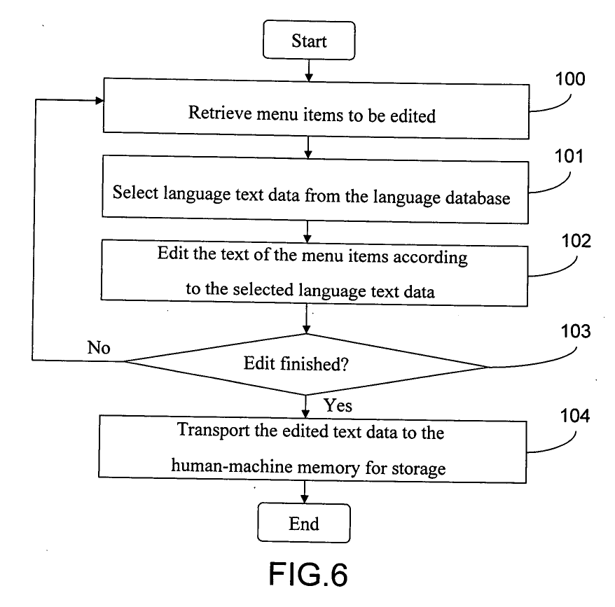

Refer to FIG. 6 for the process flow of the invention. First, retrieve menu items from a human-machine interface memory and select the menu items to be edited (step 100); next, search the language text database to select desired language text data (step 101); change the language text data of the selected menu items to the language text data of another language (step 102); determine whether editing is completed (step 103); if the editing is not yet finished, return to step 100 for continuous editing; if the editing has finished, transport the edited language text data to the human-machine interface memory 40 for storage (step 104).

The language text data editing process includes border-line setting (with or without frame), character font size and color, text direction (such as from left to right, or from right to left, or from up to down, or from down to up), and text position (such as left side alignment, center alignment or right side alignment).

By means of the language editing system of the invention, users can edit and display the menu items in the language they are familiar with. The edited language text data may then be sent to the human-machine interface memory for storage to obtain multi-language versions of menu items and improve operation convenience of the human-machine interface.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A language editing system for a human-machine interface, comprising:
a language text editing unit for retrieving and editing text data of menu items; and
a language text database containing text of multi-language versions to be used for editing the text data of the menu items.

2. The language editing system of claim 1, wherein the language text editing unit further includes border line setting to display the menu items with border-lines.

3. The language editing system of claim 1, wherein the language text editing unit further includes border line setting to display the menu items without border-lines.

4. The language editing system of claim 1, wherein the language text editing unit further includes text direction setting to display the text from a left side to a right side.

5. The language editing system of claim 4, wherein the text is displayed from the right side to the left side.

6. The language editing system of claim 4, wherein the text is displayed from a upper side to a lower side.

7. The language editing system of claim 4, wherein the text is displayed from a lower side to a upper side.

8. The language editing system of claim 1, wherein the language text editing unit further includes text position setting to align the text on a left side.

9. The language editing system of claim 8, wherein the text is aligned in the center.

10. The language editing system of claim 8, wherein the text is aligned in on a right side.

11. A language editing system for a human-machine interface, comprising:
a menu item database for storing menu items of multi-language versions for user selection; and
a language text editing unit linking to the menu item database for editing text data of the menu items.

12. The language editing system of claim 11, wherein the language text editing unit further includes border line setting to display the menu items with border-lines.

13. The language editing system of claim 11, wherein the language text editing unit further includes border line setting to display the menu items without border-lines.

14. The language editing system of claim 11, wherein the language text editing unit further includes text direction setting to display the text from a left side to a right side.

15. The language editing system of claim 14, wherein the text is displayed from the right side to the left side.

16. The language editing system of claim 14, wherein the text is displayed from a upper side to a lower side.

17. The language editing system of claim 14, wherein the text is displayed from a lower side to a upper side.

18. The language editing system of claim 11, wherein the language text editing unit further includes text position setting to align the text data on a left side.

19. The language editing system of claim 18, wherein the text is aligned in the center.

20. The language editing system of claim 18, wherein the text is aligned in on a right side.
